(19) United States
(12) Patent Application Publication
(10) Pub. No.: US 2005/0055413 A1
(43) Pub. Date: Mar. 10, 2005

(54) Method and apparatus for automatically sending away notifications in an email messaging system

(75) Inventors: Susann Marie Keohane, Austin, TX (US); Gerald Francis McBrearty, Austin, TX (US); Shawn Patrick Mullen, Buda, TX (US); Jessica Kelley Murillo, Hutto, TX (US); Johnny Meng-Han Shieh, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/655,371

(22) Filed: Sep. 4, 2003

(51) Int. Cl. G06F 15/16

(52) U.S. Cl. 709/207

(57) ABSTRACT

A method, apparatus, and computer instructions for sending a notice that a user is away. An away indication is received to enable automatic away notifications for a period of time. Email addresses of recipients to which email messages have been previously sent within a configurable time period are identified to form a set of determined email addresses. A reply is sent with a notification that the user is away only in response to receiving an email message having a same email address within a set of determined email addresses.

### BACKGROUND OF THE INVENTION

1. Technical Field

The present invention relates generally to an improved data processing system and in particular to a method and apparatus for managing email messages. Still more particularly, the present invention provides a method, apparatus, and computer instructions for managing sending of away notifications in an email messaging system.

2. Description of Related Art

The Internet, also referred to as an “internetwork”, is a set of computer networks, possibly dissimilar, joined together by means of gateways that handle data transfer and the conversion of messages from a protocol of the sending network to a protocol used by the receiving network. When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). Users may view various documents, referred to as pages, using a browser program.

The Internet also is used as a medium to provide for the exchange of messages. Specifically, electronic messages, also referred to as email messages, may be sent and received by users through the Internet. Various server computers may function as email servers to facilitate the exchange of email messages between users. Users connect to these email servers from client computers using email programs. In some cases, users may access email messages using a Web based system in which a browser is used to access the messages.

These email systems provide various features and functions. For example, a user may forward email messages received for one address to another address. Another feature is an automatic away or vacation reply. This feature, when enabled, causes a reply to be sent to all incoming mail messages addressed to a particular email address for a user. This automatic notification feature is useful in letting senders of email messages to the user know that the user is away or unavailable for some period of time. One problem with this feature is that the reply is sent to all incoming messages, including spam messages and messages from email lists with broad distribution. A user may not necessarily want everyone to know that the user is away or out of town. Further, replying to a spam message allows the sender to specifically identify the user-address as a valid address.

Therefore, it would be advantageous to have an improved method, apparatus, and computer instructions, for managing replies to received email messages.

### SUMMARY OF THE INVENTION

The present invention provides a method, apparatus, and computer instructions for sending a notice that a user is away. An away indication is received to enable automatic away notifications for a period of time. Email addresses of recipients to which email messages have been previously sent within a configurable time period are identified to form a set of determined email addresses. A reply is sent with a notification that the user is away only in response to receiving an email message having a same email address within the set of determined email addresses.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server;

FIG. 3 is a block diagram illustrating a data processing system in which the present invention may be implemented;

FIG. 4 is a diagram illustrating components used in managing away notifications;

FIG. 5 is a flowchart of a process for maintaining a list of addresses for an automatic notification feature in accordance with a preferred embodiment of the present invention;

FIG. 6 is a flowchart of a process for editing a list of addresses in accordance with a preferred embodiment of the present invention;

FIG. 7 is a flowchart of a process for managing a list of addresses in accordance with a preferred embodiment of the present invention; and

FIG. 8 is a flowchart of a process for sending notifications in accordance with a preferred embodiment of the present invention.

### DETAILED DESCRIPTION OF THE PREFERRED EMBODIMENT

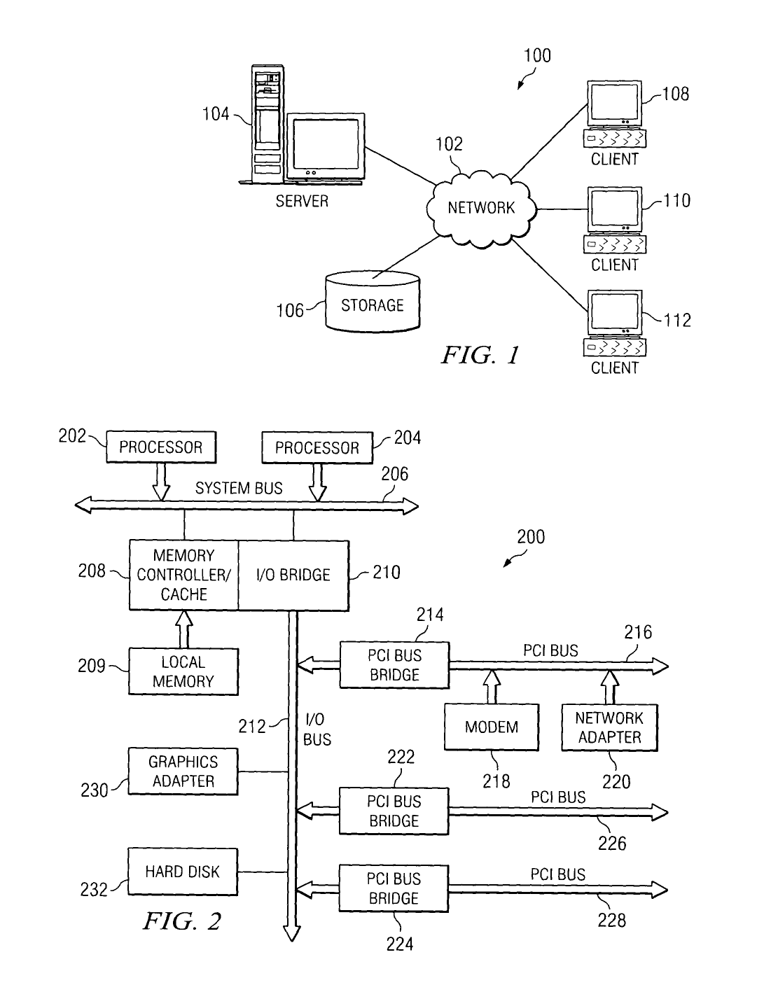

With reference now to the figures, FIG. 1 depicts a pictorial representation of a network of data processing system in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 functions as an email server to provide an email server to facilitate the exchange of email messages between different users at clients, such as clients 108-112. Network data processing system 100 may include additional servers, clients, and other devices not shown. Other servers on network data processing system 100 may provide other functions, such as providing Web pages or files.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

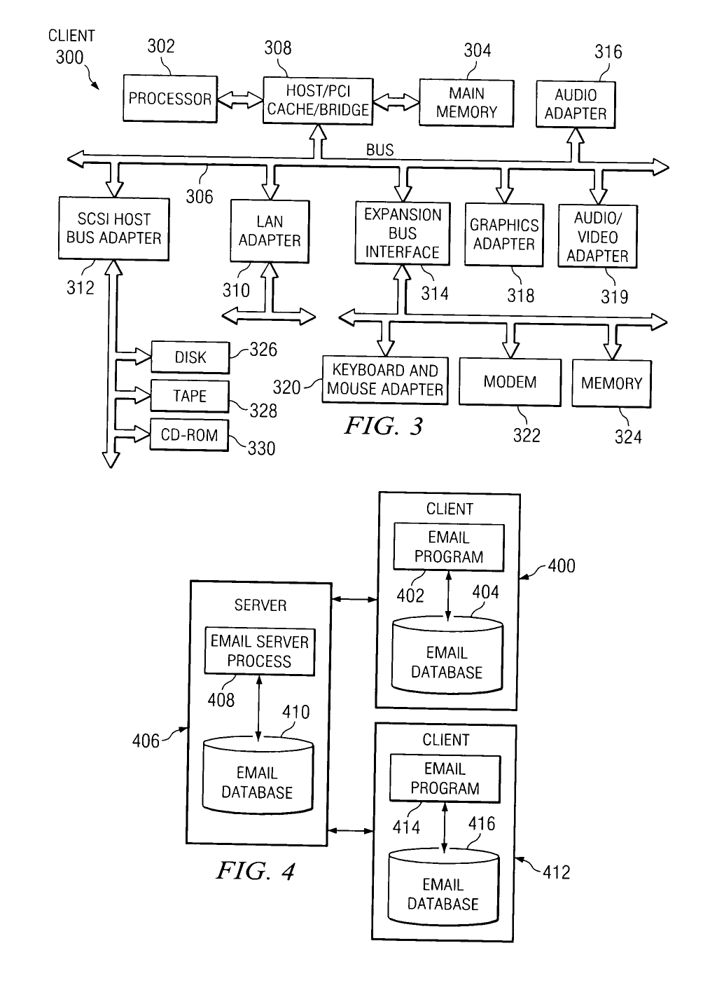

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides a method, apparatus, and computer instructions for managing automatic notifications, such as an away notification or vacation reply made when email messages are received at an address. The mechanism of the present invention selectively generates an automatic notification when an email message is received. In these examples, an automatic notification is sent only in response to messages containing an email address to which a user has recently sent an email message.

Turning next to FIG. 4, a diagram illustrating components used in managing away notifications. In this example, client 400 includes email program 402 and email database 404. Email program 402 may be, for example, Microsoft Outlook XP, which is available from Microsoft Corporation. Email program 402 also may be a browser used to access email from a Web based email server.

Email program 402 connects to server 406, which contains email server process 408 and email database 410. Email server process 408 and email program 400 may employ various protocols, such as for example, post office protocol 3 (POP3), Internet message access protocol (IMAP), or simple mail transfer protocol (SMTP). An authentication process is performed, and email server process 408 sends and receives email messages from email program 402.

Messages for a user at client 400 are stored in email database 410. In the illustrative example in FIG. 4, the user is one for which the away notifications are managed. These messages are transmitted to email program 402, which stores the messages locally in email database 404. Messages sent to other users from email program 402 may be stored in email database 410 at server 406 for transmission to recipients. For example, a recipient may be at client 412, which includes email program 414 and email database 416.

The automatic notification mechanism of the present invention is implemented as a process within email server process 408 in one embodiment. Addresses for recipients of email messages sent to email server process 408 by a user from a client, such as client 400, are stored in association with the email address for the user. In these examples the addresses stored for an email address for the user are those found in the “To” field of the email message. Additionally, email addresses in a “CC” or “BCC” field also may be stored. These fields may be automatically used or set as an option by the user. Additionally, the date of when the email message was sent also is stored. This information may be stored in a data structure, such as email database 410. Alternatively, the data structure may take other forms, such as a file or a folder associated with the user or the address for the user.

These addresses are maintained in the data structure for a configurable period of time. For example, this period of time may be configured as one month, seven months, or one year. After the period of time has expired for the address, the address is removed from the data structure. Further, the email addresses in the data structure may be edited by a user to add or remove addresses. Also, the amount of time for which an address remains in the data structure may be changed for that address such that it is different from other addresses in the data structure.

When an auto notification feature is enabled for a user or an address, email messages received for the email address or user are processed to selectively generate automatic notifications, such as an email vacation reply or some other away notification. With the mechanism of the present invention, only addresses in received email messages that also are present in the data structure are replied to in response to receiving email messages directed to the address or user. In this manner, a vacation notice is not sent to every received email message for a user or email address. In these examples, the automatic notification may be selected for an email address or a user. The user in these examples may have multiple email addresses. When a user is selected, an automatic notification is generated using the mechanism of the present invention for each email address associated with the user. A single list of addresses may be maintained for the email addresses in these examples.

For example, if a user at client 400 sends an email message to a client at 412, the email address from the user at client 412 is stored in email database 410 for some period of time. If the user at client 400 enables an away notification through email server process 408 then an email message sent by client 412 to the user at client 400 will receive a notification or reply if the period of time has not expired. Otherwise, no reply will be received by the user at client 412. In this manner, automatic notifications are selectively sent to senders of email messages to an address or a user.

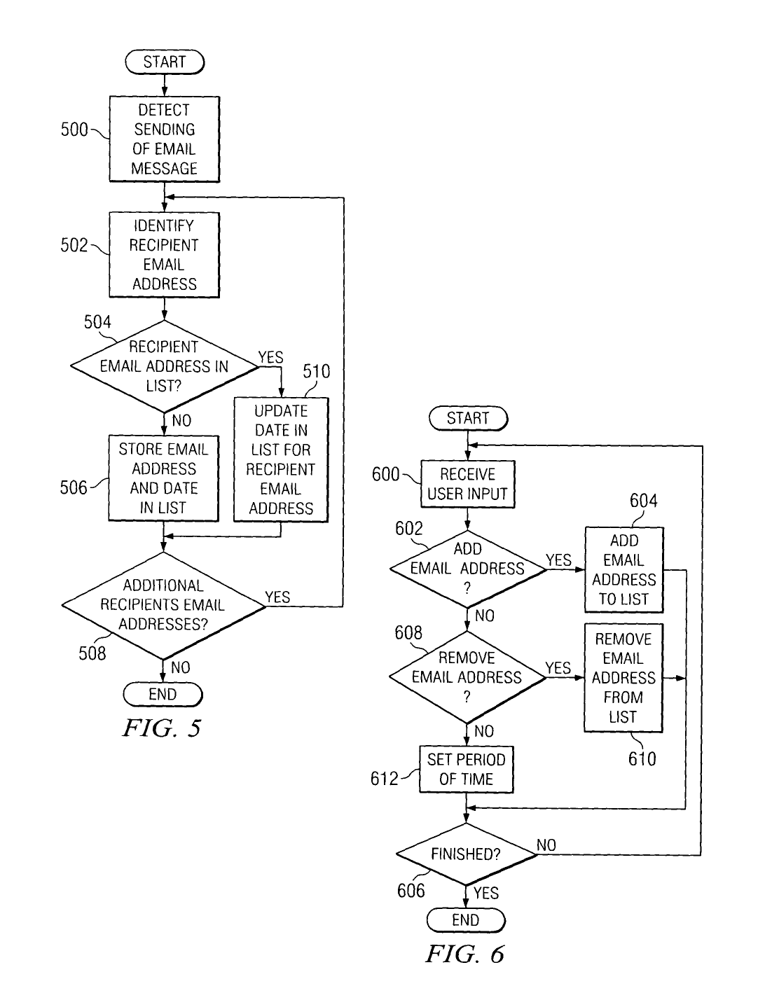

Turning now to FIG. 5, a flowchart of a process for maintaining a list of addresses for an automatic notification feature is depicted in accordance with a preferred embodiment of the present invention. The process illustrated in FIG. 5 may be implemented in a server, such as email server process 408 in FIG. 4.

The process begins by detecting the sending of an email message (step 500). A recipient address is identified (step 502). This email address is typically identified from the “To” field and also may be from other fields, such as a “CC” field and a “BCC” field. A determination is made as to whether the recipient address is located in the list for the user or sender address (step 504). In this example, the list is located in a database, such as email database 410 in FIG. 4. Of course, other data structures, such as a file may be used to store the recipient's email address.

If the recipient's address is not present in the list, the address is stored in the database along with the date (step 506). Next, a determination is made as to whether additional unprocessed recipient addresses are present (step 508). If additional recipient addresses are not present, the process terminates. Otherwise, the process returns to step 502 to identify another recipient address for processing.

With reference again to step 504, if the recipient address is in the list, the date for the recipient address in the list is updated with the new date (step 510). The process then proceeds to step 508 as described above.

Turning next to FIG. 6, a flowchart of a process for editing a list of addresses is depicted in accordance with a preferred embodiment of the present invention. The process illustrated in FIG. 6 may be implemented in an email server, such as email server process 408 in FIG. 4. This process may be employed by a user to edit email addresses on a list used to determine which email messages will receive a notification when an automatic notification feature is enabled.

The process begins by receiving a user input (step 600). A determination is made as to whether the user input is to add an email address (step 602). If the input is to add an email address, the address is then added to the list (step 604). Next, a determination is made as to whether the user is finished editing the list (step 606). If the user is finished editing the list, the process terminates. Otherwise, the process returns to step 600 as described above.

With reference back to step 602, if the user input is not to add an email address, a determination is made as to whether the user input is to remove an email address from the list (step 608). If the user input is to remove an email address, the email address is removed from the list (step 610) with the process then proceeding to step 606 as described above.

Turning back to step 608, if the user input is not to remove an email address, the user input is assumed to change the period of time for which an email address remains on the list (step 612) with the process then proceeding step 606 as described above. In these examples, this period of time may be changed for a single email address or for multiple email addresses in the list.

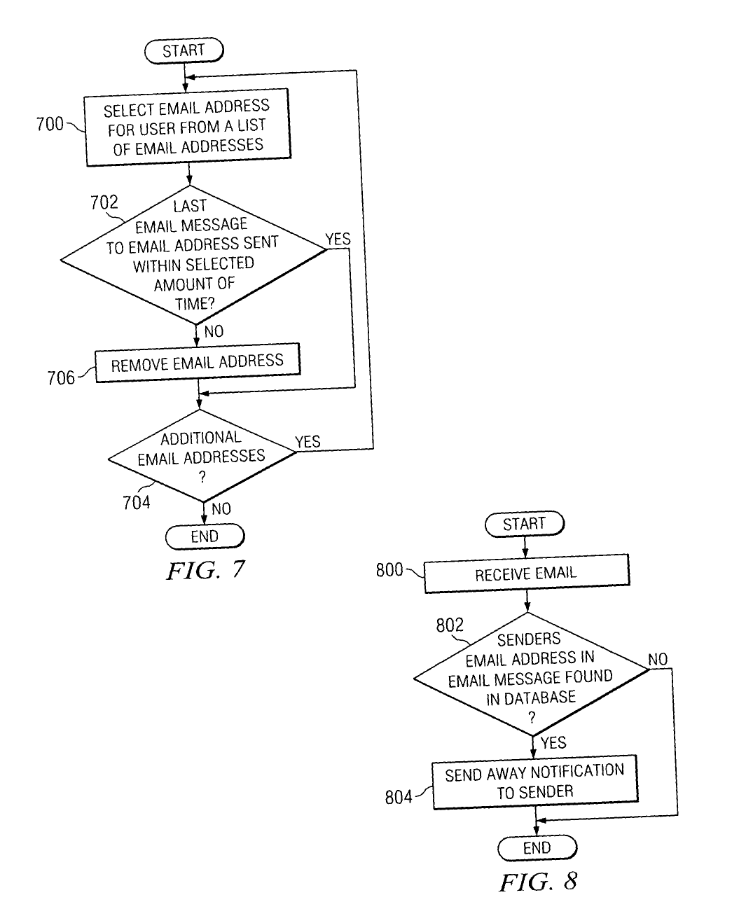

Turning next to FIG. 7, a flowchart of a process for managing a list of addresses is depicted in accordance with a preferred embodiment of the present invention. The process illustrated in FIG. 7 may be implemented in an email server, such as email server process 408 in FIG. 4.

The process begins by selecting an email address from a list of email addresses for the user (step 700). This list is a list of addresses that is used in determining which addresses should receive a notification or reply when the automatic notification feature is enabled. A determination is made as to whether the date when the last email message was sent to the email address was sent within the selected amount of time (step 702). In other words, a determination is made as to whether the period of time, for which the email address is to be retained in the list, has not expired. If the answer to this determination is yes, the email address is retained in the list, and a determination is made as to whether additional email addresses are present for processing (step 704). If additional addresses are present, the process returns to step 700. Otherwise, the process terminates.

With reference again to step 702, if the selected period of time has expired for the email address, the email address is removed from the list (step 706). The process then proceeds to step 704 as described above.

Turning next to FIG. 8, a flowchart of a process for sending notifications is depicted in accordance with a preferred embodiment of the present invention. The process illustrated in FIG. 8 may be implemented in an email server, such as email server process 408 in FIG. 4.

The process begins by receiving an email message for the address or user in which an automatic notification feature has been enabled (step 800). In response to receiving the email message, a determination is made as to whether the email address to the sender is found in the list (step 802). If the email address is found in the list, an away notification is sent to the sender (step 804) with the process terminating thereafter. In these examples, the indication is a reply message, such as “I am away on vacation and will not check my messages until I return”.

Turning back to step 802, if the sender's email address is not present in the list, the process terminates. In this case, no reply to the email message is sent even though the automatic notification feature is turned on.

Thus, the present invention provides an improved method, apparatus, and computer instructions for sending away notifications to indicate that a user is away and unavailable to check email messages. These notifications are only sent in response to email messages received from senders having an address in a list for the user receiving the email message. Addresses in the list are those from email messages the user has sent within some configurable period of time. Further, the user also may edit the list to add or remove email addresses from the list as well as change the amount of time an email address remains on the list.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The illustrated examples use an email server process as a location in which the mechanism of the present invention is implemented. The mechanism of the present invention could be implemented in other components other than an email server. For example, the mechanism of the present invention may be implemented in a client email program, such as client email program 402 in FIG. 4. In this case, the list of email addresses for the user is stored in a data structure, such as a database or file located at the client or accessible by the client. The embodiment was chosen and described in order to best explain the principles of the invention, the practical application, and to enable others of ordinary skill in the art to understand the invention for various embodiments with various modifications as are suited to the particular use contemplated.

1. A method for sending a notice that a user is away, the method comprising:
determining email addresses of recipients to which email messages have been previously sent within a configurable time period to form a set of determined email addresses; and
replying with a notification that the user is away only in response to receiving an email message having a same email address within set of determined email addresses.

2. The method of claim 1, wherein the determining step includes:
responsive to the user sending an email message to a recipient, storing an email address for the recipient and a date of the email message in the set of determined email addresses.

3. The method of claim 4, wherein the determining step further includes:
removing the email address from the list of addresses if the data is older than a selected period of time.

4. The method of claim 1, wherein the configurable time period is set by the user.

5. A data processing system for sending a notice that a user is away, the data processing system comprising:
determining means for determining email addresses of recipients to which email messages have been previously sent within a configurable time period to form a set of determined email addresses; and
replying means for replying with a notification that the user is away only in response to receiving an email message having a same email address within set of determined email addresses.

6. The data processing system of claim 5, wherein the determining means and replying means are located in an email server.

7. The data processing system of claim 5, wherein the determining means and replying means are located in an email client.

8. The data processing system of claim 5, wherein the determining means includes:
storing means for storing an email address for the recipient and a date of the email message in the set of determined email addresses in response to the user sending an email message to a recipient.

9. The data processing system of claim 10, wherein the determining means further includes:
removing means for removing the email address from the list of addresses if the data is older than a selected period of time.

10. The data processing system of claim 5, wherein the configurable time period is set by the user.

11. A computer program product in a computer readable medium for sending a notice that a user is away, the computer program product comprising:
first instructions for determining email addresses of recipients to which email messages have been previously sent within a configurable time period to form a set of determined email addresses; and
second instructions for replying with a notification that the user is away only in response to receiving an email message having a same email address within set of determined email addresses.

12. The computer program product of claim 11, wherein the first instructions includes:
sub instructions for storing an email address for the recipient and a date of the email message in the set of determined email addresses in response to the user sending an email message to a recipient.

13. The computer program product of claim 12, wherein the second instructions further include:
second sub instructions for removing the email address from the list of addresses if the data is older than a selected period of time.

14. The computer program product of claim 11, wherein the configurable time period is set by the user.
